(19) United States
(12) Patent Application Publication
(10) Pub. No.: US 2025/0392219 A1
(43) Pub. Date: Dec. 25, 2025

(54) BUCK SWITCHED MODE POWER SUPPLY AND METHOD

(71) Applicant: STMicroelectronics International N.V., Geneva (CH)

(72) Inventor: Alexandre Pons, Vizille (FR)

(21) Appl. No.: 19/199,839

(22) Filed: May 6, 2025

(30) Foreign Application Priority Data
Jun. 21, 2024 (FR) FR2406711

(51) Int. Cl. H02M 3/158; H02M 1/088

(52) U.S. Cl. CPC H02M 3/158; H02M 1/088

(57) ABSTRACT

The present description concerns a switched-mode power supply or converter and a method of controlling the converter. At each cycle in pulse-frequency modulation, the following steps are implemented. At the beginning of the cycle, a counted number of periods of a clock signal is initialized, a high-side switch is switched to the on state, and a first threshold is incremented. The counted number is updated at each period of the clock signal. The high-side switch is switched to the off state when the counted number is equal to the first threshold, and the cycle ends when the counted number is equal to a second threshold. At the end of the cycle, the first threshold is initialized if an output voltage is greater than a set point, and a new cycle begins if the output voltage is lower than the set point.

### CROSS-REFERENCE TO RELATED APPLICATIONS

This application claims the benefit of French Application No. FR2406711, filed on Jun. 21, 2024, which application is hereby incorporated herein by reference.

### TECHNICAL FIELD

The present disclosure generally concerns electronic circuits and methods, for example integrated electronic circuits and methods, and more particularly a buck switched-mode power supply or step-down switched-mode converter and its control method.

### BACKGROUND

Many known systems and applications include a buck switched-mode power supply, configured to deliver an output voltage at a target value based on a power supply voltage, the output voltage and the power supply voltage being DC (“Direct Current”) voltages. When the target value is lower than the power supply voltage, the converter is a buck or step-down converter. The output voltage is used to power a load coupled to the converter output.

There are several ways of controlling a buck switched-mode converter. In particular, it is known to control a converter in pulse-frequency modulation (PFM).

Generally, the time period for which a high-side switch of a converter is set to the on state at each operating cycle in pulse-frequency modulation of the converter is fixed. This time period may alternatively be variable so that a current in an inductor of the converter reaches a same peak value at each operating cycle, each operating cycle corresponding to a current pulse in the inductor.

However, known buck switched-mode power supplies operating in pulse-frequency modulation have disadvantages.

### SUMMARY

There exists a need to overcome all or part of the disadvantages of known buck switched-mode power supplies when they operate in pulse-frequency modulation.

There further exists a need to overcome all or part of the disadvantages of known methods of controlling in pulse-frequency modulation buck switched-mode power supplies.

An embodiment overcomes all or part of the disadvantages of known buck switched-mode power supplies.

An embodiment overcomes all or part of the disadvantages of known methods of controlling in pulse-frequency modulation buck switched-mode power supplies.

An embodiment provides a step-down switched-mode converter configured, at each operating cycle in pulse frequency modulation (Tc), to: at the start of the operating cycle, initialize a counted number of periods of a clock signal and switch a high-side switch to the ON state; increment a first threshold by a step; update the counted number of periods of the clock signal at each period of the clock signal; switch the high-side switch to the OFF state when the counted number equals the first threshold; terminate the operating cycle when the counted number equals a second threshold; and at the end of the operating cycle, compare an output voltage of the converter with a target value, initialize the first threshold to an initialization value if the output voltage is greater than the target value, and start a subsequent operating cycle if the output voltage is less than the target value.

Another embodiment provides a method of controlling a step-down switched-mode converter, the method comprising, at each operating cycle in which the converter is controlled in pulse frequency modulation: at the start of the operating cycle, initialize a counted number of periods of a clock signal and switch a high-side switch to the ON state; increment a first threshold by a step; update the counted number of periods of the clock signal at each period of the clock signal; switch the high-side switch to the OFF state when the counted number equals the first threshold; terminate the operating cycle when the counted number equals a second threshold; and at the end of the operating cycle, compare an output voltage of the converter with a target value, initialize the first threshold to an initialization value if the output voltage is greater than the target value, and start a subsequent operating cycle if the output voltage is less than the target value.

According to an embodiment, at each operating cycle in pulse frequency modulation, a low-side switch is switched to the ON state when the high-side switch is switched to the OFF state.

According to an embodiment, at each operating cycle in pulse frequency modulation, the low-side switch is switched to the OFF state at the end of the operating cycle or when an output current of the converter reaches a zero value before the end of the operating cycle.

According to an embodiment, the converter is configured to operate selectively in pulse frequency modulation or pulse width modulation.

According to an embodiment, the second threshold is configured so that a duration of each operating cycle is equal to one period of a pulse-width modulated signal.

According to an embodiment, the second threshold has a constant value.

According to an embodiment, the comparison of the output voltage with the target value is implemented with a hysteresis.

According to an embodiment, the high-side switch couples an internal node of the converter to a supply voltage of the converter.

According to an embodiment, an inductor couples the internal node to an output of the converter.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 schematically shows in the form of blocks an example of a buck or step-down DC-DC converter;

FIG. 2 illustrates, with timing diagrams, an example of operation of the converter of FIG. 1;

FIG. 3 schematically shows in the form of blocks an example of embodiment of a circuit for controlling a converter of the type of that in FIG. 1;

FIG. 4 shows, in a flowchart, an example of embodiment of a control method implemented by the circuit of FIG. 3;

FIG. 5 illustrates, with timing diagrams, an example of operation of a converter implementing the method of FIG. 4; and

FIG. 6 illustrates, with timing diagrams, another example of operation of a converter implementing the method of FIG. 3;

FIG. 7 illustrates, with timing diagrams, still another example of operation of a converter implementing the method of FIG. 3; and

FIG. 8 shows, schematically and in the form of blocks, another example of embodiment of a circuit for controlling a converter of the type of that in FIG. 1.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

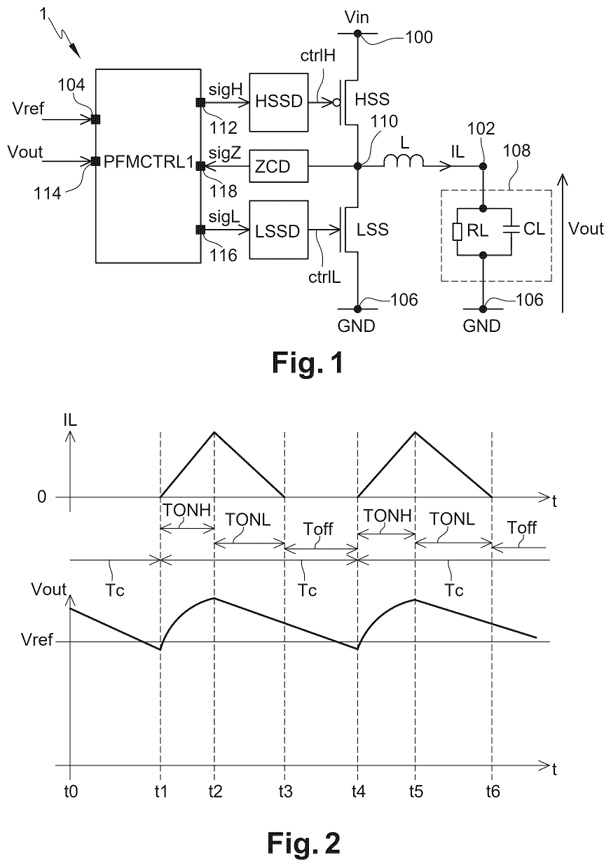

FIG. 1 schematically shows in the form of blocks an example of a buck switched-mode power supply or converter 1.

Converter 1 is configured to receive a DC power supply voltage Vin and to deliver a DC output voltage Vout. In other words, converter 1 is a DC-DC converter.

Voltage Vout is regulated by converter 1 to a set point value determined by a DC setpoint voltage Vref received by converter 1. In the present disclosure, as an example, the set point value for regulating the value of voltage Vout is the value of voltage Vref. In other words, in this example, voltage Vout is regulated to the value of voltage Vref.

Converter 1 comprises a node 100 configured to receive voltage Vin. Voltage Vout is delivered by converter 1 on an output node 102. Voltage Vref is received by an input of converter 1. As an example, voltages Vin, Vout, and Vref are all referenced to a reference potential, for example ground GND, this reference potential being received by a node 106 of converter 1.

Converter 1 is configured to deliver voltage Vout to a load to be powered 108. Load 108 is connected between nodes 102 and 106. In the example of FIG. 1, load 108 is represented by a capacitor CL and a resistor RL connected together in parallel.

Although this is not illustrated in FIG. 1, converter 1 may comprise a smoothing capacitor connected to node 102, in parallel with load 108, for example between nodes 102 and 106.

Converter 1 comprises a high-side HSS switch. The HSS switch is connected between node 100 and an inner node 110 of converter 1. In other words, the HSS switch has one conduction terminal coupled, for example connected, to node 102, and another conduction terminal coupled, for example connected, to node 110.

Converter 1 comprises an inductor L. Inductor L couples node 110 to node 102. For example, inductor L has a first terminal coupled, for example connected, to node 110, and a second terminal coupled, for example connected, to node 102.

The HSS switch is controlled by a signal ctrlH that it receives on its control terminal. Signal ctrlH is, for example, a binary signal. As an example, the HSS switch is implemented by a MOS (“Metal Oxide Semiconductor”) transistor, for example a P-channel MOS transistor, or PMOS transistor.

In the example of FIG. 1, signal ctrlH is determined by a signal sigH. For example, signal ctrlH is in a first state when signal sigH is in a first state, and in a second state when signal sigH is in a second state. For example, converter 1 comprises a driver circuit, designated with reference HSSD in FIG. 1. Circuit HSSD receives signal sigH and delivers signal ctrlH.

In other examples, circuit HSSD is omitted and signals sigH and ctrlH are one and the same.

Converter 1 comprises a control circuit PFMCTRL1. Circuit PFMCTRL1 is configured to supply the signal for controlling the HSS switch. For example, circuit PFMCTRL1 is configured to supply signal sigH, for example on an output 112 of circuit PFMCTRL1.

Here, circuit PFMCTRL1 is configured so that converter 1 operates in pulse-frequency modulation. As an example, circuit PFMCTRL1 comprises an input 104 configured to receive voltage Vref and an input 114 configured to receive voltage Vout.

In the example of FIG. 1, converter 1 further comprises a low side switch (LSS). The LSS switch is connected between nodes 102 and 106. In other words, the LSS switch has one conduction terminal coupled, for example connected, to node 102, and another conduction terminal coupled, for example connected, to node 106. The LSS switch is controlled by a signal ctrlL that it receives on its control terminal. Signal ctrlL is, for example, a binary signal. As an example, the LSS switch is implemented by a metal-oxide-semiconductor (MOS) transistor, for example an N-channel MOS transistor, or NMOS transistor.

In the example of FIG. 1, signal ctrlL is determined by a signal sigL. For example, signal ctrlL is in a first state when signal sigL is in a first state, and in a second state when signal sigL is in a second state. For example, converter 1 comprises a driver circuit (LSSD in FIG. 1). Circuit LSSD receives signal sigL and delivers signal ctrlL.

In other examples, circuit LSSD is omitted and signals sigL and ctrlL are one and the same.

Circuit PFMCTRL1 is configured to deliver the signal for controlling the LSS switch. For example, circuit PFMCTRL1 is configured to deliver signal sigL, for example on an output 116 of circuit PFMCTRL1.

As an example, to control the LSS switch, circuit PFMCTRL1 receives one or a plurality of signals enabling it to know when the current IL in inductor L is zero. For example, in FIG. 1, circuit PFMCTRL1 receives a signal sigZ indicating whether current IL is zero or not. For example, signal sigZ is received by an input 118 of circuit PFMCTRL1. For example, converter 1 comprises a circuit ZCD configured to deliver signal sigZ. For example, circuit ZCD has a terminal coupled, for example connected, to node 110.

Converter 1 comprises an inductor L. Inductor L couples node 110 to node 102. For example, inductor L has a first terminal coupled, for example connected, to node 110, and a second terminal coupled, for example connected, to node 102.

FIG. 2, shows, with timing diagrams, an example of operation of the converter of FIG. 1.

More specifically, FIG. 2 shows the variation, as a function of time t, of the current IL in inductor L, and of output voltage Vout with respect to its set point value corresponding, in this example, to voltage Vref.

At a time to, voltage Vout is higher than its set point value Vref, and current IL is zero.

At a time t1 subsequent to time to, voltage Vout becomes lower than its set point value Vref. This is detected by circuit PFMCTRL1. As a response, circuit PFMCTRL1 switches the HSS switch to the on state for a time period TONH. As a result, from time t₁, the current IL in inductor L increases, and, further, voltage Vout rises back above its set point value Vref. Time t1 also marks the beginning of an operating cycle of duration Tc.

At a time t2 subsequent to time t1, corresponding to the end of time period TONH, circuit PFMCTRL1 switches the HSS switch to the off state. Further, in this example, circuit PFMCTRL1 switches the LSS switch to the on state for a time period TONL. From time t2, current IL decreases, as does voltage Vout.

At a time t3 subsequent to time t3, the current IL in inductor L becomes zero. As a response thereto, circuit PFMCTRL1 switches the LSS switch to the off state. Time t3 thus marks the end of time period TONL.

At time t3, voltage Vout is higher than its set point value Vref. Circuit PFMCTRL1 thus does not control the beginning of a new operating cycle.

The LSS and HSS switches are kept off for a time period Toff lasting from time t3 to a time t4 when voltage Vref falls back below its set point value Vref. Time t4 marks the end of the current operating cycle, and thus of the duration Tc of this current cycle, and the beginning of a new operating cycle. In other examples, at each operating cycle, a duration Toff is provided so that the duration Tc of each operating cycle is constant.

The operation described in relation with times t1, t2, and t3 is then repeated at respective times t4, t5, and t6.

In the example of FIG. 2, time period TONH is constant. Time period TONH thus determines, with the value of voltages Vin and Vout and the value of inductance L, the quantity of charges that converter 1 supplies to its output 102, and thus to load 108, at each operating cycle.

However, the value of voltage Vin may vary during the operation of converter 1, particularly when this voltage Vin is delivered by a battery. For example, voltage Vin may vary within a range of voltage values from 6 V to 20 V, or even up to 32 V.

As a result, the average current that converter 1 can deliver on its output 102, the quantity of charges that converter 1 can deliver at each operating cycle, and the amplitude of the variations of voltage Vout around its set point value depend on voltage Vin and on voltage Vout, that is, on the power consumption of load 108.

It is then difficult, if not impossible, to find a compromise between the amplitude of the variations of voltage Vout around its set point value Vref, which is desired to be as small as possible, and the maximum current that converter 1 can deliver to its load 108, which is desired to be as large as possible.

For example, a low value lasting for time period TONH enables to limit the amplitude of the variations of voltage Vout around its set point value Vref, but results in a relatively low maximum delivered current value. Conversely, increasing time period TONH enables to increase the value of the maximum current that the converter can deliver, but results in an increase in the amplitude of the variations of voltage Vout around its set point value Vref.

To overcome the disadvantages of buck switched-mode power supplies or converters of the type described in relation with FIGS. 1 and 2, that is, converters in which, in pulse-frequency modulation, time period TONH is constant and identical at each operating cycle, it has been provided to make time period TONH dependent on voltages Vin and Vout.

However, this implies increasing the complexity of the high-side switch control circuit, which results in an increase in the surface area and in the power consumption of the converter. Further, the circuits used to make time period TONH dependent on voltages Vin and Vout are generally analog circuits comprising resistive and capacitive components with values which determine the duration TONH of each cycle. The values of these resistive and capacitive components depend on manufacturing process variations and on temperature, which is not desirable. Further, even when making time period TONH dependent on Vin and Vout, time period TONH has a maximum value determined by a maximum value of the output current and a maximum amplitude of the variations of voltage Vout. This poses a problem during load transients, when the power consumption of load 108 varies, for example increases, too rapidly with respect to the maximum current value that the converter can deliver.

The disadvantages described hereabove for known buck switched-mode power supplies where time period TONH is dependent on voltages Vin and Vout can also be encountered in other known converters where time period TONH is not fixed.

To overcome the disadvantages of known buck switched-mode power supplies or converters, for example the disadvantages of the converter 1 described in relation with FIGS. 1 and 2, there is here provided a converter in which, when the converter is operating in pulse-frequency modulation, the value of duration TONH is increased between each two successive operating cycles when, at the end of the first of the two successive cycles, voltage Vout is still lower than its set point value Vref. Time TONH is further reset to an initialization value when, at the end of an operating cycle, voltage Vout is higher than its set point value Vref. In the present description, each operating cycle in pulse-frequency modulation comprises a single switching to the on state of the high-side switch of the converter, that is, a single time period TONH.

In the provided converter, the duration Tc of each operating cycle is fixed, it being understood that two successive cycles of fixed duration Tc may be separated from each other by a dead time period.

In the provided converter, the adaptation of the value of time period TONH is implemented by a digital circuit, that is, a circuit clocked by a clock signal, which enables to avoid the disadvantages associated with the use of analog circuits, for example as concerns dispersions in resistance and/or capacitance values resulting from the manufacturing process and/or from temperature variations, or as concerns the analog circuit power consumption.

More particularly, in the provided converter, at each operating cycle in pulse-frequency modulation, the converter, for example its high-side switch control circuit, implements the following operation. At the beginning of the operating cycle, a counted number of clock signal periods is initialized, and the high-side switch is switched to the on state. Further, the value of a first threshold is incremented by a given, preferably constant, step. During the operating cycle, the counted number of periods of the clock signal is updated at each period of the clock signal, preferably at each beginning of a period of the clock signal. For example, this number is incremented by one for each new period of the clock signal. Still during the operating cycle, the high-side switch is switched to the off state when the counted number of periods of the clock signal reaches the first threshold. Thus, the first threshold determines, for each operating cycle, the time period TONH in the on state of the high-side switch. Then, when the counted number of clock signal periods reaches a second threshold greater than the first one, the second threshold preferably being fixed and constant for all operating cycles in pulse-frequency modulation, the current operating cycle ends. When the operating cycle ends, either voltage Vout is lower than its set point value Vref, and a new operating cycle begins, or voltage Vout is higher than its set point value Vref, and the value of the first threshold is reset to its initialization value.

As an example, when voltage Vout is higher than its set point value Vref at the end of an operating cycle, a new operating cycle will begin when voltage Vout will become lower than its set point value Vref.

As an example, the comparison of voltage Vout with its set point value is implemented with a hysteresis, and voltage Vout is then lower than voltage Vref when voltage Vout becomes lower than a threshold Vref-lower than set point value Vref, and is higher than voltage Vref when voltage Vout becomes higher than a threshold Vref+higher than set point value Vref. Threshold Vref+ and Vref− are determined by set point value Vref and the hysteresis value.

As an example, when the converter comprises a low-side switch, rather than a simple diode, at each operating cycle in pulse-frequency modulation, the low-side switch is switched to the on state when the high-side switch is switched to the off state. As an example, this low-side switch is switched back to the off state either when the current IL in inductor L becomes zero before the end of the operating cycle, that is, before the counted number of clock periods reaches the second threshold, or at the end of the current operating cycle if current IL has not become zero before the counted number of clock periods reaches the second threshold.

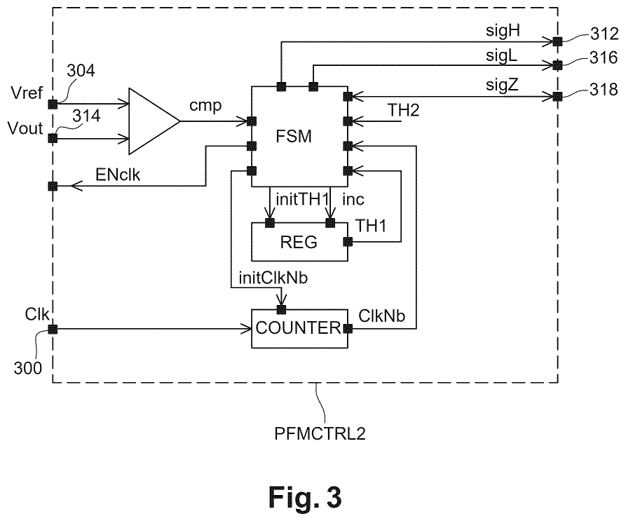

FIG. 3 shows, schematically and in the form of blocks, an example of a circuit PFMCTRL2 for controlling a converter of the type of that in FIG. 1. This circuit PFMCTRL2 is configured to implement the above-described operation when the converter is operating in pulse-frequency modulation. In FIG. 3, only circuit PFMCTRL2 is shown, which circuit PFMCTRL2 may be used as a substitute for circuit PFMCTRL1 in the previously-described converter 1.

Similarly to circuit PFMCTRL1, circuit PFMCTRL2 comprises an input 314 configured to receive voltage Vout (or a voltage which is an image of voltage Vout, for example obtained with a resistive voltage dividing bridge from voltage Vout), and an input 304 configured to receive a voltage Vref indicating the set point value of voltage Vout.

Still similarly to circuit PFMCTRL1, circuit PFMCTRL2 comprises an output 312 configured to deliver the signal sigH for controlling high-side switch HSS.

Further, in this example where the considered converter comprises a low-side switch LSS, circuit PFMCTRL2 comprises an output 316 configured to deliver the signal sigL for controlling the LSS switch. As an example, circuit PFMCTRL2 comprises an input 118 configured to receive the signal sigZ indicating when the current IL in inductor L cancels.

Circuit PFMCTRL2 further comprises an input 300 configured to receive a clock signal Clk.

Circuit PFMCTRL2 is configured to compare voltage Vout with its set point value Vref, and to deliver a signal cmp, for example a binary signal, indicating the result of this comparison. For example, circuit PFMCTRL2 comprises a circuit COMP configured to compare voltage Vout with its set point value Vref, and to deliver signal cmp.

As an example, circuit COMP is a comparator, for example implemented from an operational amplifier. Preferably, circuit COMP is a hysteresis comparator.

For example, comparator COMP has one input receiving voltage Vout (or a voltage which is an image of voltage Vout), another input receiving voltage Vref indicating the set point value of voltage Vout, and an output delivering signal cmp.

Circuit PFMCTRL2 is configured to count a number ClkNb of periods of signal Clk. For example, circuit PFMCTRL2 comprises a circuit COUNTER configured to count a number ClkNb of periods of signal Clk. Circuit COUNTER, for example a counter, comprises an input receiving signal Clk, and an output delivering number ClkNb.

Circuit COUNTER further comprises an initialization input configured to receive an initialization signal initClkNb. When signal initClkNb, for example a binary signal, is active, number ClkNb is initialized to an initialization value. For example, the initialization value of number ClkNb is a zero value when counter COUNTER is configured to increment number ClkNb at each period of signal Clk.

Circuit PFMCTRL2 is configured to set, at each operating cycle, the value of the first threshold, designated with reference TH1. In particular, circuit PFMCTRL2 is configured to initialize the value of threshold TH1 to its initial value when, at the end of an operating cycle, voltage Vout is higher than its set point value, and, at each operating cycle, to increment the value of threshold TH1 by a given step.

For example, circuit PFMCTRL2 comprises a circuit REG configured to store the current value of threshold TH1. Circuit REG comprises an input receiving an initialization signal initTH1. When signal initTH1, for example a binary signal, is active, threshold TH1 is initialized to an initialization value. Circuit REG also comprises an input receiving a signal inc. As an example, at each pulse of signal inc, for example a binary signal, the value of threshold TH1 is incremented by the value of the step. Circuit REG comprises an output providing threshold TH1, that is, the current value of threshold TH1.

Circuit PFMCTRL2 implements the previously-described operation. For example, circuit PFMCTLR2 comprises a circuit FSM, for example a state machine, for example synchronous with signal Clk, configured to deliver signals initTH1, inc, initClkNb from signals ClkNb, cmp, and TH1 and from a second threshold TH2. For example, circuit FSM receives signals ClkNb, TH1, TH2, and cmp and delivers signals inc, initClkNb, and initTH1. For example, circuit FSM is also configured to deliver signal sigH from signals TH1 and ClkNb. For example, circuit FSM delivers signal sigH. In this example, circuit FSM is also configured to deliver signal sigL from signals TH1, ClkNb, TH1, TH2, and sigL. For example, circuit FSM receives signal sigZ and delivers signal sigL.

As an example, circuit PFMCTRL2, for example its circuit FSM, may be configured, when voltage Vout falls below its set point value Vref and a new operating cycle begins, to activate with a signal ENclk an oscillator from which signal Clk is obtained. However, this signal can be omitted when the oscillator is permanently activated.

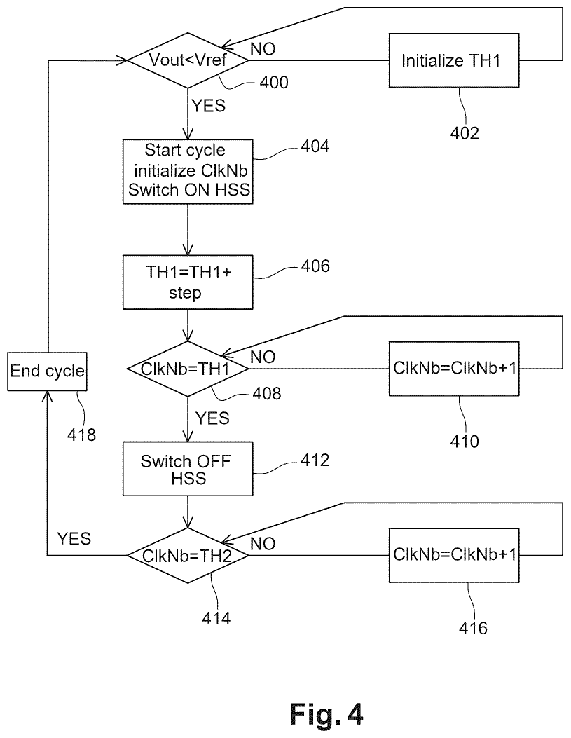

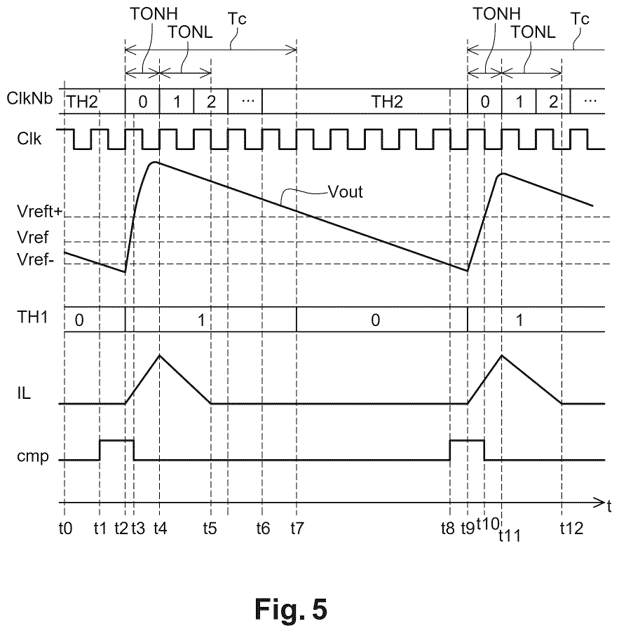

FIG. 4 shows, in a flowchart, an example of embodiment of a control method implemented by the circuit PFMCTRL2 of FIG. 3. In other words, FIG. 4 shows, in a flowchart, an example of a method of controlling a buck switched-mode power supply operating in pulse-frequency modulation, this method being for example implemented by the circuit PFMCTRL2 described in relation with FIG. 3.

At a step 400 (block “Vout <Vref”), circuit PFMCTRL2 verifies whether voltage Vout is or not lower than its set point value Vref. For example, for this purpose, circuit PFMCTRL2, for example its circuit FSM, looks at the state of signal cmp.

If voltage Vout is higher than its set point value Vref (output “NO” of block 400), it is not necessary to begin a new operating cycle in pulse-frequency modulation, and the current value of threshold TH1 is reset to its initialization value at a step 402 (block “Initialize TH1”). The initialization of threshold TH1 is implemented by circuit PFMCTRL2, for example by its circuit FSM via signal initTH1.

Step 402 loops back onto step 400, that is, is followed by step 400.

At step 400, if voltage Vout is lower than its set point value (output “YES” of block 400), a new operating cycle in pulse-frequency modulation begins.

As an example, the beginning of each operating cycle in pulse-frequency modulation may be synchronized with the beginning of a period of signal Clk, and more particularly of the first period of signal Clk beginning after voltage Vout has become lower than its set point value Vref.

As an alternative example, each operating cycle begins out of synchronization with signal Clk, as soon as voltage Vout becomes lower than its set point.

Each operating cycle begins with a step 404 (“Start cycle Initialize ClkNb Switch ON HSS” block).

At step 404, which marks the beginning of a current operating cycle, number NbClk is initialized, for example to a zero value. Further, the HSS switch is switched to the on state. For example, number NbClk is initialized by circuit PFMCTRL2, for example by its circuit FSM via signal initClkNb. For example, the HSS switch is switched to the on state by circuit PFMCTRL2, for example by its circuit FSM, via control signal sigH.

At step 404, or as a variant, at a next step 406 (block “TH1=TH1+step”), the current value of threshold TH1 is incremented by the value of the step. In this example, the value of the step is positive, and the value of threshold TH1 increases during the implementation of step 404.

At a next step 408 (block “ClkNb=TH1”), it is determined whether or not the number ClkNb of periods of signal Clk counted since the beginning of the current operating cycle is equal to threshold TH1. This step is implemented by circuit PFMCTRL2, for example by its circuit FSM, based on signals ClkNb and TH1.

At step 408, if the number ClkNb is not equal to threshold TH1 (output “NO” of block 408), for example is lower than threshold TH1, then number ClkNb is incremented at the beginning of the next period of signal Clk, at a step 410 (block “ClkNb=ClkNb+1”). Step 410 loops back onto step 408. Thus, as long as number ClkNb is not equal to the threshold TH1, number ClkNb is incremented at each period of signal Clk.

At step 408, if number ClkNb is equal to threshold TH1 (output “YES” of block 408), the method continues to a step 412 (block “Switch OFF HSS”).

As an example, when the converter comprises a low-side switch LSS, this LSS switch is switched to the on state during step 412.

The method continues at a step 414 (block “ClkNb=TH2”). Step 410 loops back onto step 408. Thus, as long as number ClkNb is not equal to threshold TH1, number ClkNb is incremented at each period of signal Clk.

At step 414, it is determined whether or not the number ClkNb of periods of signal Clk counted since the beginning of the current operating cycle is equal to threshold TH2. This step is implemented by circuit PFMCTRL2, for example by its circuit FSM, based on signals ClkNb and TH2. As an example, threshold TH2 is greater than threshold TH1 in this example where number ClkNb is incremented at each new period of signal Clk.

At step 412, if number ClkNb is not equal to threshold TH2 (output “NO” of block 412), for example is lower than threshold TH2, then number ClkNb is incremented at the beginning of the next period of signal Clk, at a step 416 (block “ClkNb=ClkNb+1”). Step 416 loops back onto step 414. Thus, as long as number ClkNb is not equal to threshold TH2, number ClkNb is incremented at each period of signal Clk.

At step 414, if number ClkNb is equal to threshold TH2 (output “YES” of block 414), the method carries on at a step 418 (block “End cycle”) marking the end of the current operating cycle in pulse-frequency modulation.

As an example, when the converter comprises low-side switch LSS, during step 414, circuit PFMCTRL2 verifies whether the current IL in inductor Lis zero. If this is the case, circuit PFMCTRL2, for example, its circuit FSM, switches the LSS switch to the off state, via signal sigL. If this is not the case until the current operating cycle in pulse-frequency modulation ends at state 418, circuit PFMCTRL2, for example, its circuit FSM, switches the LSS switch to the off state during step 418, via signal sigL.

Step 418 is followed by step 400. Thus, at the end of a cycle (step 408), if voltage Vout is still lower than its set point value Vref, a new operating cycle begins (step 404) without for threshold TH1 to have been reset (step 402), whereby the current value of threshold TH1 will be more significant during this new operating cycle than during the previous operating cycle.

As an example, when step 404 is implemented in synchronization with signal Clk, step 408 is, for example, configured to last until the end of the period of signal Clk having begun with the switching of number ClkNb to value TH2. Further, in this case, if the converter comprises the LSS switch and the latter has not already been switched to the off state, this LSS switch is switched to the off state at the end of step 418.

In the example of FIG. 4, the initialization value of threshold TH1 is such that the incrementation of threshold TH1 by the value of the step is performed prior to step 408. In another, non-illustrated example, the initialization value of threshold TH1 is determined in such a way that the incrementation of threshold TH1 by the value of the step can be performed at the end of the cycle, that is, at step 418.

FIG. 5 illustrates, with timing diagrams, an example of operation of a converter implementing the method of FIG. 4. In particular, FIG. 5 shows the variation, as a function of time, of the value of number ClkNb, of signal Clk, of voltage Vout, of the value of threshold TH1, of current IL, and of signal cmp.

More particularly, FIG. 5 illustrates the case where the power consumption of load 108 is sufficiently low, at the end of a current operating cycle in pulse-frequency modulation, for voltage Vout to be greater than its set point value, and for, for example, the next operating cycle to begin after a dead time period starting with the end of the current operating cycle and ending when voltage Vout becomes lower than its set point value.

In FIG. 5, it is considered as an example that each operating cycle in pulse-frequency modulation begins synchronously with the beginning of a corresponding period of signal Clk, and ends synchronously with the end of a corresponding period of signal Clk. However, this synchronization of the beginning and of the end of each operating cycle in pulse-frequency modulation with clock signal Clk is not essential to obtain the advantages provided by the converter and the method described herein, and those skilled in the art will be capable, based on the description of FIG. 5, of adapting the example in FIG. 5 to the case where an operating cycle in pulse-frequency modulation begins as soon as voltage Vout becomes lower than its set point value (step 400) and/or ends as soon as number ClkNb becomes equal to threshold TH1 (step 414).

In FIG. 5, as an example, signal cmp is in a high state when voltage Vout is considered as being lower than its set point value Vref, and in a low state when voltage Vout is considered as being higher than its set point value.

In FIG. 5, the comparison of voltage Vout with its set point value is implemented with a hysteresis. Voltage Vout is then considered as being lower than value Vref if it is lower than a low threshold Vref-, and higher than voltage Vref if it is higher than a high threshold Vref+. Further, when voltage Vout is between thresholds Vref+ and Vref-, the fact that voltage Vout is considered as being higher, respectively lower, than value Vref results from the fact that voltage Vout was higher than threshold Vref+, respectively lower than threshold Vref-, before being between thresholds Vref+ and Vref-. However, those skilled in the art will be capable of adapting the description made herein of FIG. 5 to the case where the comparison of voltage Vout with its set point value is made with no hysteresis.

At a time to, voltage Vout is higher than voltage Vref (cmp in the low state). Further, there is no ongoing operating cycle in pulse-frequency modulation, and current IL is thus zero. For example, time to corresponds to the implementation of step 400. Thus, since voltage Vout is lower than its set point value Vref, threshold TH1 is initialized (step 402), in this example to a zero value. As an example, number ClkNb is equal to the value TH2 that it had reached at the end of a previous operating cycle in pulse-frequency modulation.

At a next time t1, voltage Vout becomes lower than its set point value Vref, that is, in the example of FIG. 5, voltage Vout becomes lower than threshold Vref-. As a result, signal cmp switches, in this example, to the high state.

A new operating cycle in pulse-frequency modulation then begins, in this example at the beginning of the period of signal Clk following time t1, that is, at a time t2 subsequent to time t1. Time t2 corresponds to the beginning of the duration Tc of a cycle.

Thus, at time t2 of beginning of a cycle, threshold TH1 is increased by the value of the step, in this example equal to 1.

Further, at time t2 of beginning of a cycle, the HSS switch is switched to the on state, which marks the beginning of the on-state time period TONH of the HSS switch.

The setting to the on state of the HSS switch results in that current IL increases, as well as voltage Vout. In particular, in this example, voltage Vout becomes higher again than its set point value Vref, that is, than threshold Vref+ in the example of FIG. 5, at a time t3 subsequent to time t2, but within time period TONH in this example. At time t3, signal cmp switches, in this example to the low state.

Further, from time t2 until a time t4 corresponding to the beginning of the next period of signal Clk, number ClkNb is not equal to threshold TH1, and the HSS switch is kept on.

At time t4 subsequent to time t2, and in this example at time t3, number NbClk is incremented and becomes equal to 1 (step 410).

Number NbClk is then equal to the value of threshold TH1, and the HSS switch is switched to the off state (step 412). Thus, for this operating cycle, time period TONH extends from time t2 to time t4 and is determined by the value of threshold TH1.

For example, at time t4, the LSS switch is switched to the on state.

After time t4, current IL decreases, as does voltage Vout.

Further, at time t4, number ClkNb is not equal to the value of threshold TH2. As a result, at each beginning of a period of signal Clk following time t4, as long as number ClkNb has not reached threshold TH2, this number ClkNb is incremented.

At a time t5 subsequent to time t4, current IL cancels. As an example, the LSS switch is then switched to the off state. In the example of FIG. 5, the LSS switch is in the on state for a time period TONL spanning from time t4 to time t5.

At a time t6 subsequent to time t4, and in this example at time t5, a new period of signal Clk begins and number ClkNb is incremented and becomes equal to threshold TH2. The current operating cycle ends, in this example at a time t7 corresponding to the end of the period of signal CLK having started with time t6. The duration Tc of the operating cycle thus extends from time t2 to time t7 and is determined by the value of threshold TH2.

At the end of the operating cycle, in this example at time t7, since voltage Vout is still higher than its set point value Vref (cmp in the low state), threshold TH1 is initialized to its initialization value, that is, to 0 in this example. Further, a new operating cycle does not start immediately, and a dead time period begins at time t7.

After time t7, voltage Vout keeps on decreasing, until becoming lower than its set point value Vref at time t8 subsequent to time t7. A new operating cycle then begins, in this example synchronously with signal Clk at time t9 after time t8. Time to marks the end of the dead time having begun at the end time ty of the previous operating cycle.

The operation described in relation with the successive times t1, t2, t3, t4, and t5 is implemented again at the respective successive times t8, t9, t10, t11, and t12.

In particular, in the operating cycle starting at time t9, time period TONH is the same as that of the previous operating cycle starting at time t2, and corresponds to the minimum value that time period TONH can have, this minimum value being determined by the initialization value of threshold TH1. As a result, prior to each of the operating cycles starting at respective times t2 and t9, since the power consumption of the load is relatively low, voltage Vout was higher than its set point value and the value of threshold TH1 has thus been reset to its initialization value.

The predicting of a minimum time period TONH when the power consumption of the load is relatively low enables to limit the amplitude of the oscillations of voltage Vout.

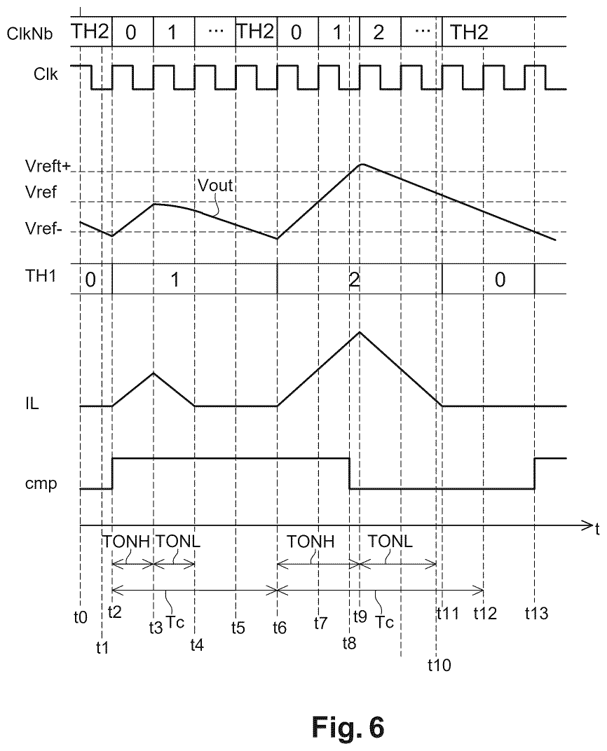

FIG. 6 illustrates, with timing diagrams, another example of operation of a converter implementing the method of FIG. 4. In particular, FIG. 6 shows the variation, as a function of time, of the value of number ClkNb, of signal Clk, of voltage Vout, of the value of threshold TH1, of current IL, and of signal cmp.

More particularly, FIG. 6 illustrates the case where the power consumption of load 108 is such that, at the end of one of the operating cycles in pulse-frequency modulation, voltage Vout is still lower than its set point value.

In FIG. 6, it is considered as an example that each operating cycle in pulse-frequency modulation begins synchronously with the beginning of a corresponding period of signal Clk, and ends synchronously with the end of a corresponding period of signal Clk. However, this synchronization of the beginning and of the end of each operating cycle in pulse-frequency modulation with clock signal Clk is not indispensable to obtain the advantages provided by the converter and the method described herein, and those skilled in the art will be capable, based on the description of FIG. 6, of adapting the example of FIG. 6 to the case where an operating cycle in pulse-frequency modulation begins as soon as Vout becomes lower than its set point value (step 400) and/or ends as soon as number ClkNb becomes equal to threshold TH1 (step 414).

In FIG. 6, as an example, signal cmp is in a high state when voltage Vout is considered as being lower than its set point value Vref, and in a low state when voltage Vout is considered as being higher than its set point value.

In FIG. 6, the comparison of voltage Vout with its set point value is implemented with a hysteresis, as in FIG. 5. However, those skilled in the art will be capable of adapting the description given herein of FIG. 6 to the case where the comparison of voltage Vout with its set point value is performed with no hysteresis.

At a time to, voltage Vout is greater than voltage Vref (cmp in the low state). Further, there is no ongoing operating cycle in pulse-frequency modulation, and current IL is thus zero. For example, time to corresponds to the implementation of step 400. Thus, since voltage Vout is lower than its set point value Vref, threshold TH1 is initialized (step 402), in this example to a zero value. As an example, number ClkNb is equal to the value TH2 that it had reached at the end of a previous operating cycle in pulse-frequency modulation.

At the next time t1, voltage Vout becomes lower than its set point value Vref, that is, in the example of FIG. 6, voltage Vout becomes lower than threshold Vref-. As a result, signal cmp switches, in this example, to the high state.

A new operating cycle in pulse-frequency modulation then begins, in this example at the beginning of the period of signal Clk following time t1, that is, at a time t2 subsequent to time t1. Time t2 corresponds to the beginning of the duration Tc of a cycle.

Thus, at time t2 of beginning of a cycle, threshold TH1 is increased by the value of the step, in this example equal to 1.

Further, at time t2 of beginning of a cycle, the HSS switch is switched to the on state, which marks the beginning of the on-state time period TONH of the HSS switch.

The switching to the on state of the HSS switch results in that current IL increases, as does voltage Vout.

Further, from time t2 until a time t3 corresponding to the beginning of the next period of signal Clk, number ClkNb is not equal to threshold TH1, and the HSS switch is kept on.

At time t3 subsequent to time t2, number NbClk is incremented and becomes equal to 1 (step 410).

Number NbClk is then equal to the value of threshold TH1, and the HSS switch is switched to the off state (step 412). Thus, for this operating cycle, time period TONH extends from time t2 to time t3 and is determined by the value of threshold TH1.

As an example, at time t3, the LSS switch is switched to the on state. This marks the beginning of the on-state time period TONL of the LSS switch for this operating cycle.

After time t3, current IL decreases, as does voltage Vout.

Further, at time t3, number ClkNb is not equal to the value of threshold TH2. As a result, at each beginning of a period of signal Clk following time t3, as long as number ClkNb has not reached threshold TH2, this number ClkNb is incremented.

At a time t4 subsequent to time t3, current IL becomes zero. As an example, the LSS switch is then switched to the off state, which marks the end of time period TONL for this operating cycle. In the example of FIG. 5, the LSS switch is thus in the on state for a time period TONL spanning from time t3 to time t4.

At a time t5 subsequent to time t3, and, in this example, at time t4, a new period of signal Clk begins and number ClkNb is incremented and becomes equal to threshold TH2. The current operating cycle ends, in this example, at a time t6 corresponding to the end of the period of signal Clk having started with time t5. The duration Tc of the operating cycle thus extends from time t2 to time t6 and is determined by the value of threshold TH2.

At the end of the operating cycle, in this example at time t6, since voltage Vout is lower than its set point value Vref (cmp in the high state), threshold TH1 is not reset to its initialization value, and further, a new operating cycle in pulse-frequency modulation begins at time t6.

Thus, at time t6, number ClkNb is initialized to its initialization value, that is, a zero value. Further, the value of threshold TH1 is incremented by the value of the step, that is, by 1. Further, the HSS switch is switched to the on state, which marks the beginning of a new on-state time period TONH of the HSS switch. The switching to the on state of the HSS switch results in that current IL increases, as does voltage Vout.

Further, from time t6 until a time t7 corresponding to the beginning of the next period of signal Clk, number ClkNb is not equal to threshold TH1, and the HSS switch is kept on.

At time t7 subsequent to time t6, number NbClk is incremented and becomes equal to 1 (step 410).

However, from time t7 until a time to corresponding to the beginning of the next period of signal Clk, number ClkNb is not equal to threshold TH1, and the HSS switch is kept on.

At time t9, number NbClk is incremented and becomes equal to 2 (step 410). Number NbClk is then equal to the value of threshold TH1, and the HSS switch is switched to the off state (step 412). Thus, for this operating cycle, time period TONH extends from time t6 to time t8 and is determined by the value of threshold TH1. Since the value of threshold TH1 is greater for the cycle starting at time t6 than for the cycle starting at time t2, time period TONH is longer for the cycle starting at time t6 than for the cycle starting at time t2.

In the example of FIG. 6, at a time t8 between times ty and t9, voltage Vout becomes higher than its set point value, that is, than threshold Vref+ in this example, and signal cmp switches, in this example to the low state.

As an example, at time t9, the LSS switch is switched to the on state, which marks the beginning of the duration TONL of the current operating cycle.

After time t9, current IL decreases, as does voltage Vout.

Further, at time t9, number ClkNb is not equal to threshold value TH2. As a result, at each beginning of a period of signal Clk following time t9, as long as number ClkNb has not reached threshold TH2, this number ClkNb is incremented.

At a time t10 subsequent to time t9, current IL becomes zero. As an example, the LSS switch is then switched to the off state. In the example of FIG. 6, the LSS switch is in the on state for a time period TONL spanning from time t9 to time t10.

At a time t11 subsequent to time t9, and, in this example, at time t10, a new period of signal Clk begins and number ClkNb is incremented and becomes equal to threshold TH2. The current operating cycle ends, in this example, at a time t12, corresponding to the end of the period of signal Clk having begun with time t11. The duration Tc of the operating cycle thus extends from time t6 to time t12 and is determined by the value of threshold TH2.

At the end of the operating cycle, in this example at time t12, since voltage Vout is higher than its set point value Vref (cmp in the low state), threshold TH1 is reset to its initialization value. A new operating cycle in pulse-frequency modulation will start after voltage Vout has become lower again that its set point value, for example at a time t13 subsequent to time t12.

FIG. 6 shows that, when the load consumes more power than in the example of FIG. 5, the value of time period TONH is increased at each operating cycle until voltage Vout becomes higher again than its set point value Vref. In other words, FIG. 6 shows that time period TONH is adapted to each operating cycle in pulse-frequency modulation as a function of the power consumption of the load and, for example, of the variations of voltage Vin.

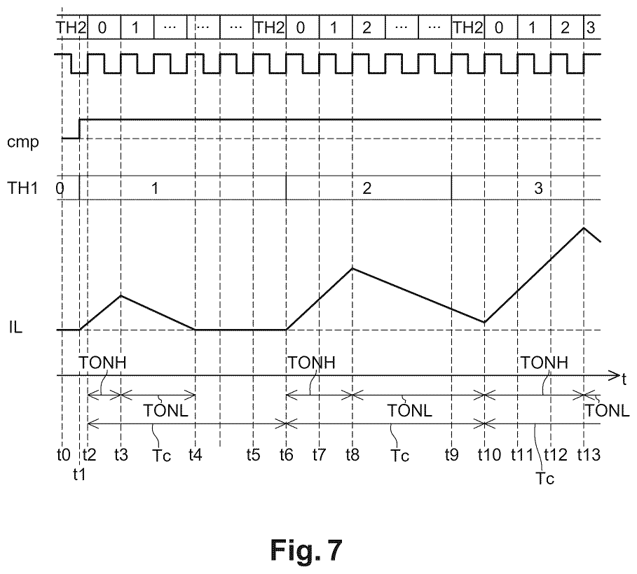

FIG. 7 illustrates, with timing diagrams, still another example of operation of a converter implementing the method of FIG. 4. In particular, FIG. 7 shows the variation, as a function of time, of the value of number ClkNb, of signal Clk, of signal cmp, of the value of threshold TH1, and of current IL.

More particularly, FIG. 7 illustrates the case of a load transient where the power consumption of load 108 increases significantly and such that, in the absence of an adaptation of time period TONH, the converter would not be capable of regulating voltage Vout to its set point value Vref.

In FIG. 7, it is considered as an example that each operating cycle in pulse-frequency modulation begins synchronously with the beginning of a corresponding period of signal Clk, and ends synchronously with the end of a corresponding period of signal Clk. However, this synchronization of the beginning and of the end of each operating cycle in pulse-frequency modulation with clock signal Clk is not indispensable to obtained the advantages provided by the converter and the method described herein, and those skilled in the art will be capable, based on the description of FIG. 7, of adapting the example of FIG. 6 to the case where an operating cycle in pulse-frequency modulation begins as soon as voltage Vout becomes lower than its set point value (step 400) and/or ends as soon as number ClkNb becomes equal to threshold TH1 (step 414).

In FIG. 7, as an example, signal cmp is in a high state when voltage Vout is considered as being lower than its set point value Vref, and in a low state when voltage Vout is considered as being higher than its set point value.

In FIG. 7, although this is not illustrated, the comparison of voltage Vout with its set point value is, as an example, implemented with a hysteresis, as in FIGS. 5 and 6. However, those skilled in the art will be capable of implementing the case where the comparison of voltage Vout with its set point value is made with no hysteresis.

At a time to, voltage Vout is higher than voltage Vref (cmp in the low state). Further, there is no ongoing operating cycle in pulse-frequency modulation, and current IL is thus zero. For example, time to corresponds to the implementation of step 400. Thus, since voltage Vout is lower than its set point value Vref, threshold TH1 is initialized (step 402), in this example to a zero value. As an example, number ClkNb is equal to the value TH2 that it had reached at the end of a previous operating cycle in pulse-frequency modulation.

At the next time t1, voltage Vout becomes lower than its set point value Vref and cmp signal switches, in this example, to the high state.

A new operating cycle in pulse-frequency modulation then begins, in this example at the beginning of the period of signal Clk following time t1, that is, at a time t2 subsequent to time t1. Time t2 corresponds to the beginning of the duration Tc of a cycle.

Thus, at time t2 of beginning of a cycle, threshold TH1 is increased by the value of the step, in this example equal to 1.

Further, at time t2 of beginning of a cycle, the HSS switch is switched to the on state, which marks the beginning of the on-state time period TONH of the HSS switch.

The setting to the on state of the HSS switch results in that current IL increases, as does voltage Vout.

Further, from time t2 until a time t3 corresponding to the beginning of the next period of signal Clk, number ClkNb is not equal to threshold TH1, and the HSS switch is kept on.

At time t3 subsequent to time t2, number NbClk is incremented and becomes equal to 1 (step 410).

Number NbClk is then equal to the value of threshold TH1, and the HSS switch is switched to the off state (step 412). Thus, for this operating cycle, time period TONH extends from time t2 to time t3 and is determined by the value of threshold TH1.

As an example, at time t3, the LSS switch is switched to the on state, which marks the beginning of period TONL for the current operating cycle.

After time t3, current IL decreases, as does voltage Vout.

Further, at time t3, number ClkNb is not equal to the value of threshold TH2. As a result, at each beginning of a period of signal Clk following time t3, as long as number ClkNb has not reached threshold TH2, this number ClkNb is incremented.

At a time t4 subsequent to time t3, current IL becomes zero. As an example, the LSS switch is then switched to the off state. In the example of FIG. 5, the LSS switch is in the on state for a time period TONL spanning from time t3 to time t4.

At a time t5 subsequent to time t3, and in this example at time t4, a new period of signal Clk begins and number ClkNb is incremented and becomes equal to threshold TH2. The current operating cycle ends, in this example at time t6, corresponding to the end of the period of signal Clk having started at time t5. The duration Tc of the operating cycle thus extends from time t2 to time t6 and is determined by the value of threshold TH2.

At the end of the operating cycle, in this example at time t6, since voltage Vout is lower than its set point value Vref (cmp in the high state), threshold TH1 is not reset to its initialization value, and a new operating cycle in pulse-frequency modulation begins at time t6.

Thus, at time t6, number ClkNb is initialized to its initialization value, that is, here, a zero value. Further, the value of threshold TH1 is incremented by the value of the step, that is, by 1. Further, the HSS switch is switched to the on state, which marks the beginning of a new on-state time period TONH of the HSS switch. The setting to the on state of the HSS switch results in that current IL increases, as does voltage Vout.

Further, from time t6, until a time t7 corresponding to the beginning of the next period of signal Clk, number ClkNb is not equal to threshold TH1, and the HSS switch is kept on.

At time t7 subsequent to time t6, number NbClk is incremented and becomes equal to 1 (step 410).

However, from time t7 until a time t8 corresponding to the beginning of the next period of signal Clk, number ClkNb is not equal to threshold TH1, and the HSS switch is kept on.

At time t8, number NbClk is incremented and becomes equal to 2 (step 410). Number NbClk is then equal to the value of threshold TH1, and the HSS switch is switched to the off state (step 412). Thus, for this operating cycle, time period TONH extends from time t6 to time t8 and is determined by the value of threshold TH1. Since the value of threshold TH1 is higher for the cycle starting at time t6 than for the cycle starting at time t2, time period TONH is longer for the cycle starting at time t6 than for the cycle starting at time t2.

As an example, at time t8, the LSS switch is switched to the on state, which marks the beginning of time period TONL for the current operating cycle.

After time t8, current IL decreases, as does voltage Vout.

Further, at time t8, number ClkNb is not equal to threshold value TH2. As a result, at each beginning of a period of signal Clk following time t8, as long as number ClkNb has not reached threshold TH2, this number ClkNb is incremented.

At a time t9 subsequent to time t8, a new period of signal Clk begins, and number ClkNb is incremented and becomes equal to threshold TH2. The current operating cycle ends, in this example at time t10, corresponding to the end of the period of signal Clk which has started at time t9. The duration Tc of the operating cycle thus extends from time t6 to time t10 and is determined by the value of threshold TH2.

Further, at time t10, current IL is not zero. As an example, due to the fact that current IL has not cancelled between time t8 and time t10, the LSS switch has remained on, and this LSS switch is switched to the off state at the end of the cycle, that is, at time t10. The time period TONL for this current operating cycle thus extends from time t8 to the time t10 corresponding to the end of the current operating cycle.

At the end of the operating cycle, in this example at time t10, since voltage Vout is lower than its set point value Vref (cmp in the low state), threshold TH1 is not reset to its initialization value, and, further, a new operating cycle in pulse-frequency modulation begins at time t10.

Thus, at time t10, number ClkNb is initialized to its initialization value, that is, here, a zero value. Further, the value of threshold TH1 is incremented by the value of the step, that is, by 1. Further, the HSS switch is switched to the on state, which marks the beginning of a new on-state time period TONH of the HSS switch. The setting to the on state of the HSS switch results in that current IL increases, as does voltage Vout.

Further, from time t10 until a time t11 corresponding to the beginning of the next period of signal Clk, number ClkNb is not equal to threshold TH1, and the HSS switch is kept on.

At time t11 subsequent to time t10, number NbClk is incremented and becomes equal to 1 (step 410).

However, from time t11 until a time t12 corresponding to the beginning of the next period of signal Clk, number ClkNb is not equal to threshold TH1, and the HSS switch is kept on.

At time t12 subsequent to time t11, number NbClk is incremented and becomes equal to 2 (step 410).

However, from time t12 until a time t13 corresponding to the beginning of the next period of signal Clk, number ClkNb is not equal to threshold TH1, and the HSS switch is kept on.

At time t13, number NbClk is incremented and becomes equal to 3 (step 410). Number NbClk is then equal to the value of threshold TH1, and the HSS switch is switched to the off state (step 412). Thus, for this operating cycle, duration TONH extends from time t10 to time t13 and is determined by the value of threshold TH1. Since the value of threshold TH1 is greater for the cycle starting at time t10 than for the cycles starting at the respective times t2 and t6, time period TONH is longer for the cycle starting at time t10 than for the cycles starting at the respective times t2 and t6.

As an example, at time t13, the LSS switch is switched to the on state, which marks the beginning of the time period TONL for the current operating cycle.

As compared with the examples described in relation with FIGS. 5 and 6, where, at each operating cycle, current IL cancels before the end of the cycle, in the example of FIG. 7, current IL does not cancel during the cycle starting at time t6, whereby, during the next cycle starting at time t9, current IL increases from a non-zero value. In other words, the converter and the control method provided herein allow an operation in continuous conduction mode (CCM), which is not possible in known converters where the beginning of the new operating cycle in pulse-frequency modulation is conditioned by a zero value of current IL, so that these known converters can only operate in discontinuous conduction mode (DCM). The operation described in relation with FIG. 7 enables the converter to absorb load transients, that is, it enables the converter to keep on regulating voltage Vout to its set point value Vref even when the power consumption of its load increases abruptly, for example since the load switches from a standby mode to an active mode.

In the above-described embodiments, the converter operates in pulse-frequency modulation. The converter then comprises, to implement the described operation, for example, a circuit PFMCTRL1 for controlling the HSS switch and, when the converter comprises it, the LSS switch.

In alternative embodiments, the converter is configured to operate selectively in pulse-frequency modulation as described hereabove, and in pulse-width modulation (PWM). In other words, the converter is configured to alternate phases where the converter operates in pulse-frequency modulation, as described hereabove, and phases where the converter operates in pulse-width modulation.

As an example, in this case, to simplify transitions between an operation in pulse-frequency modulation and an operation in pulse-width modulation, threshold TH2 may be selected so that the duration Tc of each operating cycle in pulse-frequency modulation is equal to the duration of one period of a pulse-width modulated signal, this PWM signal being, for example, a signal for controlling the HSS switch. For example, in this case, the beginnings of the operating cycles in pulse-frequency modulation are synchronized with the beginning of the periods of a pulse-width modulation clock signal. For example, the Clk signal used in pulse-frequency modulation is obtained from the pulse-width modulation clock signal, for example by frequency division of the pulse-width modulation clock signal.

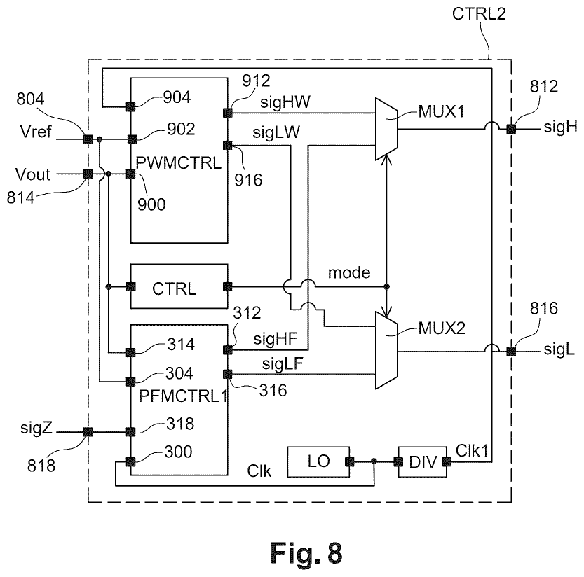

FIG. 8 shows, schematically and in the form of blocks, another example of embodiment of a circuit CTRL2 for controlling a converter of the type of that in FIG. 1.

In this example, circuit CTRL2 is configured to implement the above-described operation when the converter operates in pulse-frequency modulation, and, further, to selectively operate in pulse-frequency modulation and in pulse-width modulation. In FIG. 7, only circuit CTRL2 is shown, which circuit CTRL2 may be used as a replacement for circuit PFMCTRL1 in the above-described converter 1.

Similarly to circuit PFMCTRL1, circuit CTRL2 comprises an input 814 configured to receive voltage Vout (or a voltage image of voltage Vout, for example obtained with a resistive voltage dividing bridge from voltage Vout), and an input 804 configured to receive a voltage Vref indicating the set point value of voltage Vout.

Also similarly to circuit PFMCTRL1, circuit CTRL2 comprises an output 812 configured to deliver the signal sigH for controlling the high-side switch HSS.

Further, in this example where the considered converter comprises a low-side switch LSS, circuit CTRL2 comprises an output 816 configured to deliver signal sigL for controlling the LSS switch. As an example, circuit CTRL2 comprises an input 818 configured to receive the signal sigZ indicating when the current IL in inductor L cancels.

When the converter operates in pulse-frequency modulation, circuit CTRL2 delivers signals sigH and sigL identical to those delivered by circuit PFMCTRL2. When the converter operates in pulse-width modulation, circuit CTRL2 delivers a pulse-width modulated signal sigH, and signal sigL is, for example, complementary to signal sigH.

For example, circuit CTRL2 comprises circuit PFMCTRL1 and a circuit PWMCTRL. Circuit PFMCTRL1 is configured to deliver signals sigH and sigL in pulse-frequency modulation operation, and circuit PWMCTRL is configured to deliver signals sigH and sigL in pulse-width modulation operation.

For example, the input 304 of circuit PFMCTRL2 is coupled, for example connected, to input 804, input 814 being coupled, for example connected, to input 814 and input 318 being coupled, for example connected, to input 818.

For example, the output 312 of circuit PFMCTRL2 is coupled to output 812, for example by a selection circuit MUX1, output 316 being coupled to output 816, for example by another selection circuit MUX2. In the example of FIG. 8, the signal delivered by output 312, respectively 316, is designated with reference sigHF, respectively sigLF.

As an example, circuit CTRL2 comprises an oscillator LO configured to deliver signal Clk to the input 300 of circuit PFMCTRL2. As an alternative example, circuit CTRL2 comprises an input configured to receive signal Clk, this input being coupled, for example connected, to the input 300 of circuit PFMCTRL2.

As an example, circuit PWMCTRL comprises an input 900 configured to receive voltage Vout (or a voltage image of voltage Vout, for example obtained with a resistive voltage dividing bridge based on voltage Vout), and an input 904 configured to receive voltage Vref indicating the set point value of voltage Vout. As an example, inputs 900 and 902 are coupled, for example connected, to the respective inputs 814 and 804.

As an example, circuit PWMCTRL comprises an output 912 configured to deliver a signal sigHW corresponding to signal sigH when the converter operates in pulse-width modulation.

Further, in this example where the considered converter comprises a low-side switch LSS, circuit PWMCTRL comprises an output 916 configured to deliver a signal sigLW corresponding to the signal sigL for controlling the LSS switch when the converter operates in pulse-width modulation.

For example, the output 912 of circuit PWMCTRL is coupled to output 812, for example, by selection circuit MUX1, output 916 being coupled to output 814, for example, by the other selection circuit MUX2. In the example of FIG. 8, the signal delivered by output 312, respectively 316, is designated with reference sigHF, respectively sigLF.

As an example, circuit PWMCTRL comprises an input 904 configured to receive a periodic signal Clk1 at the frequency of the pulse-width modulated signal sigHW. As an example, the pulse-width modulation clock signal Clk1 is obtained from signal Clk, by dividing the frequency of signal Clk, for example with a frequency dividing circuit DIV.

As an example, circuit CTRL2 comprises a circuit CTRL configured to deliver a signal mode for selecting the pulse-frequency modulation operating mode or the pulse-width modulation operating mode. For example, signal mode controls circuits MUX1 and MUX2 so that signals sigH and sigL receive the respective signals sigHW and sigLW in pulse-width modulation, and the respective signals sigHF and sigLF in pulse-frequency modulation.

For example, circuit CTRL comprises an input configured to receive voltage Vout, and the switching from one operating mode to the other is achieved at least partly based on the current value of voltage Vout.

As an alternative example, circuit CTRL is omitted, and circuit CTRL2 comprises an input configured to receive signal mode.

Those skilled in the art will be capable of providing other circuits CTRL2 configured to selectively operate in pulse-frequency modulation and in pulse-width modulation, in which the operation in pulse-frequency modulation is implemented as previously described in relation with FIGS. 3 to 7.

Various embodiments and variants have been described. Those skilled in the art will understand that certain features of these various embodiments and variants could be combined, and other variants will become apparent to those skilled in the art.

In particular, although embodiments and variants have been described in which the converter considered as an example comprises a low-side switch LSS, the above-described operation, and, in particular the control of the high-side switch HSS in a pulse-frequency modulation operation, may be implemented in a converter comprising a diode instead of the LSS switch. In this case, the output 316 of circuit PFMCTRL2 and the output 816 of circuit CTRL2 may be omitted.

As an example, a converter implementing the above-described pulse-frequency modulation operation may be used in the automotive industry. For example, this converter may be used in vehicles, for example, electric, to generate a relatively low power supply voltage for electronic circuits, based on a relatively high power supply voltage, for example provided by a battery of the vehicle.

As another example, a converter implementing the above-described pulse-frequency modulation operation can be used in industry, for example in the industry of energies, for example green energies. For example, such a converter may be used to convert a relatively high DC voltage, for example obtained from a solar panel or a wind turbine, into a relatively low DC voltage, for example to power electronic circuits.

As another example, a converter implementing the above-described pulse-frequency modulation operation may be used in the field of the Internet of Things (IoT). For example, such a converter may be used to convert a relatively high DC voltage, for example delivered by a battery of an IoT device, into a relatively low DC voltage, for example to power electronic circuits of the IoT device.

As another example, a converter implementing the above-described pulse-frequency modulation operation can be used in the field of personal wireless devices, for example in cell phones, for example to convert a relatively high DC voltage, for example delivered by a battery of the device, into a relatively low DC voltage, for example to power electronic circuits of the device.

In the above-described embodiments and variants, in each operating cycle in pulse-frequency modulation, counter COUNTER is initialized at the beginning of the cycle and then incremented with each period of signal Clk, and threshold TH2 is then greater than threshold TH1, so that when number ClkNb reaches threshold TH2, this corresponds to a number of periods of signal Clk greater than when number ClkNb reaches threshold TH1. Further, in this case, the value of the step is positive, so that incrementing threshold TH1 by the value of the step amounts to increasing time period TONH. However, those skilled in the art will be capable of adapting the described examples where number ClkNb is increasing to examples where, for each operating cycle in pulse-frequency modulation, counter COUNTER is initialized at the beginning of the cycle and decrements number ClkNb at each period of signal Clk. In such examples, threshold TH2 is then lower than threshold TH1, so that when number ClkNb reaches threshold TH2, this corresponds to a number of periods of signal Clk greater than when number ClkNb reaches threshold TH1. Further, in this case, the value of the step is negative, so that incrementing threshold TH1 by the value of the step amounts to decreasing the value of threshold TH1, and thus to increasing time period TONH.

Finally, the practical implementation of the described embodiments and variants is within the abilities of those skilled in the art, based on the functional indications given hereabove.

What is claimed is:

1. A step-down switched-mode converter configured, at each operating cycle in pulse-frequency modulation, to:
at a start of the operating cycle, initialize a counted number of periods of a clock signal and switch a high-side switch to an ON state;
increment a first threshold by a step;
update the counted number of periods of the clock signal at each period of the clock signal;
switch the high-side switch to an OFF state in response to the counted number of periods equaling the first threshold;
terminate the operating cycle in response to the counted number of periods equaling a second threshold; and
at an end of the operating cycle, compare an output voltage of the converter with a target value, initialize the first threshold to an initialization value in response to the output voltage being greater than the target value, and start a subsequent operating cycle in response to the output voltage being less than the target value.

2. The converter according to claim 1, in which, at each operating cycle in pulse-frequency modulation, a low-side switch is switched to the ON state in accordance with the high-side switch being switched to the OFF state.

3. The converter according to claim 2, wherein, at each operating cycle in pulse-frequency modulation, the low-side switch is switched to the OFF state at the end of the operating cycle or in response to an output current of the converter reaching a zero value before the end of the operating cycle.

4. The converter according to claim 1, wherein the converter is configured to operate selectively in pulse-frequency modulation or pulse width modulation.

5. The converter according to claim 4, wherein the second threshold is configured so that a duration of each operating cycle is equal to one period of a pulse-width modulated signal.

6. The converter according to claim 1, wherein the second threshold has a constant value.

7. The converter according to claim 1, wherein the compare of the output voltage with the target value is implemented with a hysteresis.

8. The converter according to claim 1, wherein the high-side switch couples an internal node of the converter to a supply voltage of the converter.

9. The converter according to claim 8, further comprising an inductor coupling the internal node to an output of the converter.

10. A method of controlling a step-down switched-mode converter, the method comprising, at each operating cycle in which the converter is controlled in pulse-frequency modulation:
at a start of the operating cycle, initializing a counted number of periods of a clock signal and switch a high-side switch to an ON state;
incrementing a first threshold by a step;
updating the counted number of periods of the clock signal at each period of the clock signal;
switching the high-side switch to an OFF state in response to the counted number of periods equaling the first threshold;
terminating the operating cycle in response to the counted number of periods equaling a second threshold; and
at an end of the operating cycle, comparing an output voltage of the converter with a target value, and starting a subsequent operating cycle in response to the output voltage being less than the target value.

11. The method according to claim 10, further comprising, at an end of the subsequent operating cycle, initializing the first threshold to an initialization value in response to the output voltage being greater than the target value.

12. The method according to claim 10, further comprising, at each operating cycle in pulse-frequency modulation, switching a low-side switch to the ON state in accordance with the high-side switch being switched to the OFF state.

13. The method according to claim 12, further comprising, at each operating cycle in pulse-frequency modulation, switching the low-side switch to the OFF state at the end of the operating cycle or in response to an output current of the converter reaching a zero value before the end of the operating cycle.

14. The method according to claim 10, further comprising selectively operating the converter in pulse-frequency modulation or pulse width modulation.

15. The method according to claim 14, wherein the second threshold is configured so that a duration of each operating cycle is equal to one period of a pulse-width modulated signal.

16. The method according to claim 10, wherein the second threshold has a constant value.

17. The method according to claim 10, further comprising implementing the comparing of the output voltage with the target value with a hysteresis.

18. The method according to claim 10, wherein the high-side switch couples an internal node of the converter to a supply voltage of the converter.

19. The method according to claim 18, wherein an inductor couples the internal node to an output of the converter.

20. A method of controlling a step-down switched-mode converter, the method comprising, at each operating cycle in which the converter is controlled in pulse-frequency modulation:
at a start of the operating cycle, initializing a counted number of periods of a clock signal and switch a high-side switch to an ON state;
incrementing a first threshold by a step;
updating the counted number of periods of the clock signal at each period of the clock signal;
switching the high-side switch to an OFF state in response to the counted number of periods equaling the first threshold;
terminating the operating cycle in response to the counted number of periods equaling a second threshold; and
at an end of the operating cycle, comparing an output voltage of the converter with a target value, and initializing the first threshold to an initialization value in response to the output voltage being greater than the target value.
